(19) United States
(12) Patent Application Publication
(10) Pub. No.: US 2024/0389783 A1
(43) Pub. Date: Nov. 28, 2024

(54) CAPSULE SYSTEM

(71) Applicant: SOCIETE DES PRODUITS NESTLE S.A., Vevey (CH)

(72) Inventors: ARAMIA ASMAR, Yverdone-les-bains (CH); AUDREY VIRGINIE MURPHY, Cossonay (CH); MARILYNE ISABELLE BONIN, Les Grangettes (FR); NIHAN DOGAN, La Croix-sur-Lutry (CH)

(21) Appl. No.: 18/696,066

(22) PCT Filed: Sep. 28, 2022
(86) PCT No.: PCT/EP2022/076883

§ 371 Date: Mar. 27, 2024

(30) Foreign Application Priority Data
Sep. 28, 2021 (EP) 21199582.4

(51) Int. Cl. A47J 31/06; B65D 65/46; B65D 85/804

(52) U.S. Cl. CPC A47J 31/0673; B65D 65/466; B65D 85/8064; B65D 2565/381

(57) ABSTRACT

The invention concerns system for producing a beverage in a beverage preparation machine, comprising:—a capsule (1), said capsule comprising a capsule body (2) with a circumferential annular flange (24), a top membrane (3), a bottom membrane (4) and an opening device (5) provided inside the chamber for opening the capsule by relative engagement of said opening device with the bottom membrane (4) under the effect of a rise in pressure of the injected liquid in the ingredient chamber (22), and—a beverage preparation machine (10) comprising a capsule holder (11) and a liquid injection device (12). wherein the liquid injection device and the inserted capsule holder are relatively moveable one to the other so as to clamp the circumferential annular flange (24) of the capsule, and—an annular support element (100) positionable between the lower surface (242) of the circumferential annular flange (24) of the capsule and the circumferential annular rim (112) of the capsule holder.

### FIELD OF THE INVENTION

The present invention relates to a system for preparing a beverage in a beverage preparation machine with a capsule that comprises a beverage ingredient.

### BACKGROUND OF THE INVENTION

Single-serve beverage capsules are known in the art. These capsules are commonly used with beverage preparation machines for on demand dispensing of beverages, like coffee or tea.

For this, usually a beverage capsule with a capsule body that encloses a beverage ingredient is inserted in a capsule receiver of a beverage preparation machine. The capsule receiver is closed and the beverage preparation is started. In the capsule receiver, a top membrane of the capsule is punctured with a needle to inject a fluid, generally water, in the capsule to interact with the beverage ingredient inside the capsule to produce the desired beverage. The fluid fills the capsule so that the pressure inside the capsule increases. When a sufficient amount of fluid fills the capsule, a self-opening mechanism in the capsule is activated and opens a bottom membrane of the capsule to release the prepared beverage at a time when the extraction of the beverage component is completed. Examples of working principles of this type of container are described in patent EP1472156.

In the prior art, beverage containers of this type are usually made of plastic and/or aluminium.

Considering that the containers are designed for single time use only, their disposal has to be managed since reusing and recycling the materials used can be challenging. Therefore, attempts are made to replace these materials with alternatives, like cellulose or bioplastic, which allow overcoming the problems existing with disposing and/or recycling the containers after use. However, it has to be considered that these alternative materials do not have the same material characteristics and advantages as the usual plastic materials. For example, the strength of a seal formed between compostable materials used for the top membrane on one side and the container body on the other side is different from the strength of a seal between a plastic container body and a plastic multilayer top membrane.

In particular, the strength of a seal formed between a top membrane and a container body that are both made from compostable materials appears to be insufficient to enable a correct extraction in the beverage preparation machine. During the beverage preparation, the seal between the top membrane and the container body is typically subjected to high temperatures (70° C.-100° C.) and pressures (>7-9 bar). Thus, if the seal does not have sufficient strength, there is a risk that the seal between the top membrane and the container body is damaged during extraction. This can lead to fluid leaking from the container during the beverage preparation as the pressure applied on a weak seal can cause the top membrane separating from the container body or may lead to the top membrane bursting along the seal. As a consequence, the build-up of pressure in the container may be insufficient for activating the self-opening mechanism, the container may not be completely extracted and/or the beverage may contain insoluble particles of the substrate to be extracted, thereby leading to a deterioration of the taste and quality of the prepared beverage.

Therefore, it is an object of the present invention to provide a capsule system that allows preparing a beverage in a beverage preparation machine with a beverage capsule, which is made from compostable materials, without having to compromise on quality and taste of the prepared beverage. Therein, it is a particular object of the invention to increase the resistance of the top membrane against separation from the capsule body during extraction and to reduce the risk of the top membrane breaking during extraction.

These and other objects, which become apparent upon reading the description, are solved by the subject-matter of the independent claims. The dependent claims refer to preferred embodiments of the invention.

### SUMMARY OF THE INVENTION

A first aspect of the invention relates to a system for producing a beverage comprising a capsule, a beverage in a beverage preparation machine and an annular support element.

The capsule comprises a capsule body containing the beverage ingredient, a top membrane. a bottom membrane and an opening device.

The capsule body comprises:
a side wall defining a chamber and extending axially between a top opening and a bottom outlet that is usually opened and through which the beverage is dispensed, and
a circumferential annular flange projecting radially outward from the top opening, said flange comprising an upper surface opposite to the chamber with respect to the opening and an opposed lower surface.

Preferably, the capsule body is made of biodegradable or compostable materials, such as polylactic acid (PLA), polyhydroxyalcanoates (PHA), polybutylene succinate (PBS), polybutylene succinate adipate (PBSA), and/or polybutylene adipate terepthalate (PBAT).

Therein, international standards, such as EU 13432 or US ASTM D6400, specify technical requirements and procedures for determining biodegradability and compostability of a material. For example, one of the tests requires that—for a material to be considered “(industrially) compostable”—at least 90% of the material in question must be biologically degraded under controlled conditions in 6 months. Similar test schemes exist also for a certification to home compostability.

Thus, it is possible to dispose the entire capsule system after its use in compost piles so that earth can be supplied with nutrients once the material has completely broken down.

The top membrane of the capsule is attached to at least a part of the upper surface of the circumferential flange of the capsule body, closes the top opening, and is adapted to be punctured for liquid injection into the capsule.

Preferably, this top membrane is made of biodegradable or compostable materials, such as polylactic acid (PLA), polyhydroxyalcanoates (PHA), polybutylene succinate (PBS), polybutylene succinate adipate (PBSA), and/or polybutylene adipate terepthalate (PBAT).

The bottom membrane of the capsule is provided inside the chamber. With the top membrane, it delimits a beverage ingredient chamber that is filled with a beverage ingredient. This beverage ingredient can be a soluble or extractable beverage ingredient.

The opening device of the capsule provided inside the chamber and below the bottom membrane. It is designed for opening the capsule by relative engagement with the bottom membrane under the effect of a rise in pressure of the injected liquid in the ingredient chamber.

Preferably, this opening device is made of a biodegradable or compostable material.

Preferably the whole capsule is made of a biodegradable or compostable material.

The system comprises a beverage preparation machine that comprises a removable capsule holder for receiving a capsule outside the machine and holding the capsule inside the machine.

This capsule holder comprises:
a capsule receiving area configured to receive and hold the sidewall of the capsule body, and
a circumferential annular rim extending radially outward from the receiving area and configured to support the circumferential annular flange of the capsule bod.

In addition, the machine comprises:
an aperture for inserting the removable capsule holder,
a liquid injection device.

This liquid injection device and the inserted capsule holder are relatively moveable one to the other so as to clamp the circumferential annular flange of the capsule.

Usually, the liquid injection device comprises at least one injection member arranged to project into the top membrane, when the device is moved to the holder. This injection member supplies a liquid inside the capsule.

Preferably the beverage preparation machine can correspond to the machine described in WO2006082064 or WO2008107281.

The system comprises an annular support element that is positionable between the lower surface of the circumferential annular flange of the capsule and the circumferential annular rim of the capsule holder.

This annular support element is configured in size and shape for being simultaneously:
axially seated above the circumferential annular rim of the capsule holder, and
axially positioned below the flange of the capsule body.

When the assembly of this annular support element positioned between the capsule holder and the capsule is inserted inside the machine, this assembly forms a circumferential clamping region for clamping the capsule flange in the beverage preparation machine during the beverage preparation. This clamping region includes the top membrane and the flange of the body capsule, with the effect that these two elements are strongly pressed one to another during the beverage preparation. As a result, the risk of separation of these two elements during the beverage preparation is avoided.

Thus, by providing a capsule system with such configuration, problems existing in the prior art can be overcome. In particular, the configuration of the capsule system contributes to enhancing the seal integrity of the top membrane of compostable capsules (but also in general of all capsules with membranes that are difficult to seal to a capsule body) during extraction because the system design increases resistance to separation of the top membrane from the capsule flange or breaking of said top membrane. Beverages can be prepared with water pressurised above 10 bar without impacting the seal integrity.

Generally, the annular support element presents a shape that is similar to the shape of the circumferential annular rim of the capsule holder and to the flange of the capsule body. Usually, this annular support element is a ring. This ring can be a flat ring or a round ring.

Thereby, the support element can be provided with a simple but effective design.

The annular support element may be made of a rigid material, such as steel or of an elastic material, such as rubber. Alternatively or additionally, the support element may be made of a compostable and/or recyclable material. For example, (bio)plastic, paper or silicone may be used.

On one preferred embodiment, the annular support element is a flat ring. This flat ring comprises an upper surface configured to support the lower surface of the circumferential annular flange of the capsule body and this upper surface can comprise at least one annular protruding portion. The protruding portion can present any shape. For example, it can present a semi-circular radial cross-section.

By providing the upper surface of the flat ring with a defined surface feature that may project therefrom and may extend circumferentially with the perimeter of the flat ring, a number of effects can be derived that ensure the integrity of the seal along the capsule flange.

According to a further preferred embodiment, the protruding portion may be provided between an inner edge and an outer edge of the flat ring. The protruding portion may preferably be provided such that it is radially closer to the inner edge than to the outer edge. For instance, the protruding portion may extend at the inner edge.

Preferably, the annular support element can comprise an orientation feature for ensuring that it is seated on the flange via the protruding portion. The orientation feature can be a colour or a sticker, or a surface structure corresponding with a contour of the capsule body or of the capsule holder.

Usually, the highest axial thickness of the annular support element depends on the axial thickness of the flange of the capsule body. It can also depend on the nature of the material the capsule body is made of.

Generally, the highest axial thickness of the annular support element, preferably at least in a region of the protruding portion, may be between 0.1 mm and 0.7 mm, preferably between 0.3 mm and 0.5 mm. Alternatively or additionally, the support element may have said axial thickness at least in a region of the protruding portion. Thereby, it is possible to provide a support element with a thickness that enables the use in beverage preparation machines known in the prior art while enhancing the aforementioned advantages.

According to a preferred embodiment, a capsule body supporting section is attached to the annular support element. This capsule body supporting section is designed to receive the capsule body when the circumferential flange of the capsule body is seated on the ring.

Preferably this capsule body supporting section comprises a cage-like structure, that can have an annular bottom support portion for supporting the bottom of the capsule body at a side opposite to the top opening of said capsule body. This annular bottom support portion can be attached to the ring via axial connection ribs.

Usually, the center of said annular bottom support portion is void.

This capsule body supporting section provides the advantage of facilitating the positioning of the annular support element under the capsule body flange: the user is urged to slide the capsule inside the annular support element.

This embodiment is particularly interesting when the upper surface of the annular support element comprises an annular protruding portion because there is no risk that the user inverses the upper and lower faces when positioning the annular support element under the capsule body flange.

In addition, when the annular support element is non disposable and re-usable for each beverage preparation, this embodiment presents the advantage of preventing the user to throw the annular support element with a used capsule. Due to its shape and volume, the support element is more visible and draws the attention of the user, which may not be the case when the support element is a ring hidden under the used capsule body flange.

Thereby, the risk of a consumer accidentally loosing or damaging the support element can be reduced as the size of the support element can be increased making it more visible and easier to insert in a capsule holder. In addition, it can be ensured that the capsule is arranged correctly with respect to the support element.

In a second aspect, there is provided a method to prepare a beverage with the system such as describes above, wherein:
the annular support element is positioned under the circumferential annular flange of the capsule or above the circumferential annular rim of the capsule holder, then
the capsule is placed in the capsule receiving area of the capsule holder, then
the capsule holder is inserted in the capsule holder receiving area of the machine,
the liquid injection device and/or the inserted capsule holder is/are moved one to the other, then
liquid is injected.

In a third aspect, there is provided a kit of at least one capsule and at least one annular support element configured to be used in the system such as described above.

The capsule presents the features described above and the annular support element is configured to be removably positioned below the circumferential annular flange of the capsule.

Preferably, the annular support element is a ring such as described above.

This kit can comprise several capsules and one annular support element, which enables a user to prepare beverages from the capsules by positioning the single annular support element below the flange of each capsule body and removing it after preparation.

In a fourth aspect, there is provided a ring configured to be used in the system such as described above. This ring comprises an upper surface and a lower surface, and the upper surface comprises an annular protruding portion. This protruding portion can present any shape like a semi-circular radial cross-section.

Preferably the ring can comprise an orientation feature for differentiating the upper and lower faces.

The orientation feature can be a colour or a sticker, or a surface structure corresponding with a contour of the capsule body or of the capsule holder.

In one embodiment the ring is attached to a capsule body supporting section such as described above.

In a fifth aspect, there is provided a capsule holder configured to be used in the system such as described above wherein an annular support element is attached to the circumferential annular rim of the capsule holder. The upper surface of the attached ring comprises an annular protruding portion. This protruding portion can be a semi-circular radial cross-section.

The annular support element, preferably a ring, can be attached to the holder in a removable manner. In that case, the current holder of the machine can be adapted to receive new capsules with weaker sealing between the top membrane and the capsule body flange, such as compostable or biodegradable capsules.

Alternatively, the ring can be attached in a non-removable manner to the holder, meaning the ring is integrated in the holder when it is manufactured. This new holder can be used in place of the current holder with new types of capsules that present weaker sealing between the top membrane and the capsule body flange, such as compostable or biodegradable capsules.

Thereby, it is possible to provide the capsule holder of the beverage preparation machine with the support element. Accordingly, the capsule holder of the beverage preparation machine can ensure maintenance of the integrity of the seal of the capsule. Also, the risk of a consumer accidentally loosing or damaging the support element can be reduced and the support element can be arranged consistently and accurately relative to the other components of the capsule system.

In the present application,
the terms “top”, “bottom” are used to describe the relational positioning of features of the invention. These terms should be understood to refer to the capsule in its normal orientation when positioned in the beverage preparation machine for the production of a beverage as shown in the FIGS. 1, 2, 3A, 3B and 8A to 8B.
the term “axial” is defined in relation with the capsule body of the capsule that extend axially between a top opening and a bottom and the term “radial” is defined in relation with circular transversal sections of this capsule body (FIG. 1).

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Further features, advantages and objects of the invention will become apparent for the skilled person when reading the following detailed description of embodiments of the invention and when taking in conjunction with the figures of the enclosed drawings. In case numerals have been omitted from a figure, for example for reasons of clarity, the corresponding features may still be present in the figure.

FIG. 1 shows a schematic cross-section of a capsule used in the system of the present invention,

FIG. 2 shows a system of a capsule and beverage preparation machine according to prior art,

FIGS. 3A and 3B are cross section views of the capsule and the capsule holders of FIGS. 1 and 2 in two different operations,

FIGS. 4 to 7 illustrates top view and cross section of different embodiments of the annular support element according to the invention,

FIG. 8A to 8E are magnified views of the flange of the capsule clamped in the beverage preparation machine according to prior art and different embodiments of the present invention,

### DETAILED DESCRIPTION OF EXEMPLARY EMBODIMENTS

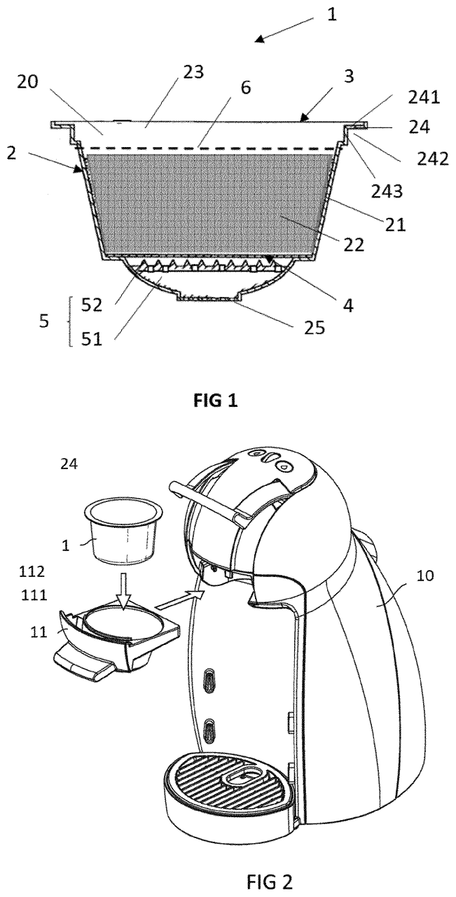

FIG. 1 illustrates schematically a capsule 1 used in the system of the present invention.

The capsule 1 comprises a capsule body 2 with one or more sidewall(s) 22 that extend axially from a bottom towards a top. The sidewall extends towards a top opening 23. At the top opening 23, the body comprises a circumferential flange 24 that extends radially outward from the sidewall and that continuously extend along the circumference of the opening. Usually, the flange 24 is connected with the capsule body by a connecting portion 243. For example, at the connecting portion 243 the sidewall(s) 22 may transition into the flange 24.

The flange 24 is usually integrally formed with the one or more side walls 22. The flange comprises an upper surface 241 facing the top and a lower surface 242. The lower surface preferably comprises, or consists of, a flat surface.

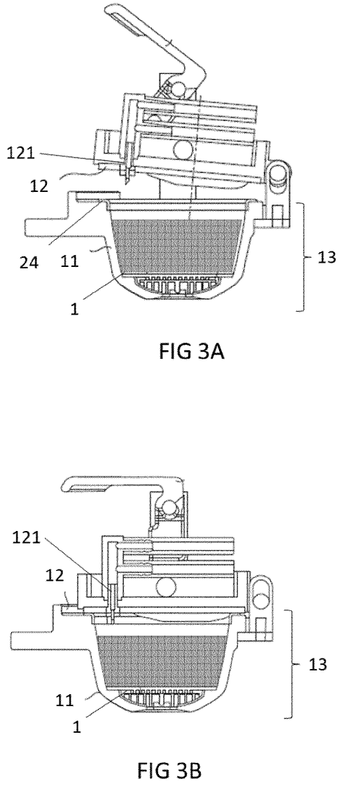

Generally, any transversal cross section of the body capsule is circular from the bottom to the top and the flange is circular too as illustrated in the perspective view of FIG. 2.

The sidewall delimits a chamber 21 for containing a soluble and/or extractable beverage ingredient.

This soluble beverage ingredient is a water soluble powder ingredient and can be selected within the list of: instant coffee powder, milk powder, cream powder, instant tea powder, cocoa powder, soup powder, fruit powder or mixture of said powders. The powders can be agglomerated or sintered.

This beverage ingredient packed in the package can also be an ingredient able to be extracted or infused like a roast and ground coffee, or tea leaves. In that embodiment water extracts the beverage ingredient.

The capsule comprises a top membrane 3 that is fixed, sealed or attached to at least a part of the upper surface 241 of the circumferential flange and accordingly covers and closes the top opening 23.

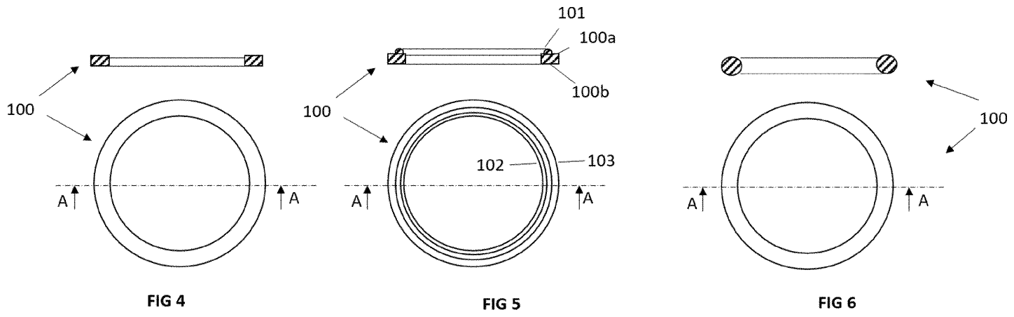

This top membrane is adapted to be punctured for liquid injection into the capsule as illustrated in FIG. 3B. Preferably, the top membrane is pierceable by an injection needle of the beverage preparation machine which is adapted to inject an extraction liquid under pressure inside or into the chamber. Preferably, the puncturing operation is made at one single place by a water injection needle such as described in WO2006/082064 or WO2008/107281.

The term “top membrane” should be understood as the membrane which is pierced by the injection needle of machine, as opposed to the “bottom membrane” (such as described below) which should be understood as the membrane located on the opposite side of the capsule 1.

The capsule comprises a bottom membrane 4 that closes the bottom of the chamber 21.

Accordingly, the soluble and/or extractable beverage ingredient is enclosed between the top and bottom membranes. The top and bottom membranes delimit an internal space of the chamber, the ingredient chamber 22, configured to hold the beverage ingredient for the preparation of a beverage.

In one embodiment, a distributor wall 6 can extend through the internal cross section of the chamber defining an inferior sub-chamber for the ingredient and a superior distribution chamber for the liquid. This distributor wall comprises small holes to distribute liquid uniformly on the ingredient.

The capsule comprises an opening device 5 adapted to open the chamber by relative engagement with the bottom membrane 4 under the effect of the liquid pressure increase in the chamber during injection of said liquid. The opening device 5 may comprise a rigid plate 51 comprising opening elements 52 such as spikes, cone- or pyramid-shaped—optionally truncated at their ends—on its surface turned upwardly towards the bottom membrane 4 which may form protrusions and recesses against the bottom membrane 4 facing the opening device.

The opening device 5 may be generally referred to as “pyramid plate”. Upon liquid injection inside the chamber 4, pressure builds up, which deforms the bottom membrane 4 against the opening means 5, until the bottom membrane is pierced, giving way to the beverage prepared inside the capsule 1 respectively chamber 21 below the opening device 5. The expression “engagement” may mean that, for instance, the opening device or the second membrane, or alternatively both may be moved with respect to each other to effect opening.

Usually, the capsule body comprises a bottom opened beverage outlet 25, below the opening device 5. The bottom of the capsule body preferably extends below the opening means to hold said opening means and collect the beverage to this opened beverage outlet 25 dispensing the beverage outside of the capsule 1, e.g. into a cup.

The top membrane 3 is fixed to the flange 24 in such a way that the extraction liquid injected into the chamber 21 increases internal pressure up to the pressure necessary to obtain the piercing of the deformed bottom membrane 4 by the opening device 5. The top membrane 3 is thus fixed to the flange in such a way that it does not detach at least until a defined pressure inside of the chamber is achieved. This defined pressure may be at least 2 bars, preferably at least 3 bars or at least 6 bars. Thereby, the fixation effects that the capsule 1 does not leak via the interface between the flange and the top membrane during beverage preparation.

Preferably the capsule 1 is a compostable capsule.

Yet, the present invention can be applied with any capsule 1 made of materials presenting a weak sealing between the capsule flange and the top membrane. Preferably, at least the capsule body 2 and the top membrane 3 are made of compostable materials, even more preferably all the elements of the capsules are made of material(s) and/or contain substances that are (all) compostable.

Usually, the top membrane 3 is attached to the flange 24 by heat sealing, with or without the addition of sealant. Thus, a seal is formed between the first membrane and the flange.

Depending on the nature of the materials of the top membrane and the flange:
either the seal itself can be weak, or
the material itself can present a low resistance to pressure, for example a top membrane made a laminated film can be subjected to delamination.

FIG. 2 shows a system of a capsule 1 such as describes above and a beverage preparation machine 10 configured to prepare a beverage from said capsule. The machine comprises a capsule holder 11 removeable from the machine and comprising a receiving area 111 to introduce the body of the capsule while the flange 24 of the body is supported on the circumferential rim 112 of the holder. Then the capsule holder can be inserted in a receiving area 13 of the machine to prepare a beverage.

The machine comprises a capsule holder receiving area 13 for inserting the removable capsule holder where the capsule holder can be inserted to prepare a beverage.

In addition, the machine comprises, above the receiving area 13 for the capsule holder, a liquid injection device 12 with an injection member 121, precisely a hollow needle configured to pierce the top membrane 3 and to inject water inside the capsule. This injection device and the capsule holder are moveable relatively so as to clamp the circumferential annular flange of the capsule.

Then, the capsule holder 11 can be positioned in two positions inside the receiving area 13 as illustrated in FIGS. 3A and 3B.

In FIG. 3A, the capsule holder 11 has just been introduced inside the receiving area 13 and in FIG. 3B, the liquid injection plate 12 is moved to the inserted capsule holder and clamps the circumferential annular flange 24 of the capsule between the circumferential rim 112 of the holder and the injection plate 12.

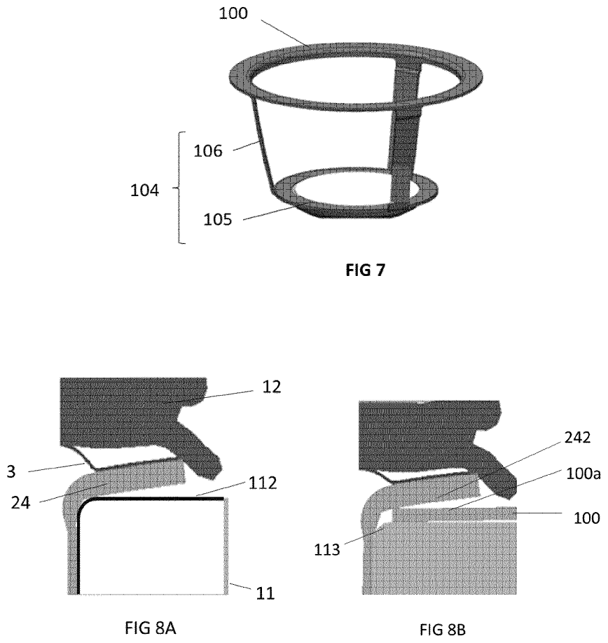

FIG. 4 illustrates the top view and the cross section according to AA of one embodiment of the annular support element 100 that is part of the system of a capsule 1 and a machine 10 such as described above.

The annular support element 100 is a flat ring. The surface of the annular support element is planar. This surface may extend substantially within one plane.

Alternatively or additionally, the annular support element 100 may comprise an annular protruding portion. FIG. 5 illustrates this alternative embodiment of the annular support element 100 of FIG. 4: the flat ring presents a protruding portion 101 at the upper surface 100a of the flat ring whereas the lower surface 100b is flat. The protruding portion extends along the whole circumference of the ring and forms an annular bump or rib. Preferably, this protruding portion 101 is positioned closer to the inner edge 102 of the ring than to the outer edge, as explained below.

FIG. 6 illustrates another embodiment of the annular support element 100 of FIGS. 4 and 5: the annular support element 100 is a round ring.

In all the embodiments of the annular support element 100, preferably, the annular support element 100 may be made of a compostable and/or recyclable material. For example, the support element 100 may be made of plastic, paper or silicone. It is also conceivable that the support element 200 may be made of a rigid material, such as steel. Alternatively or additionally, the support element 100 may be made of an elastic material, such as rubber. For example, the support element 100 may be a silicone O-ring. The support element 100 may have any cross section shape or form. For example, the cross section of the support element may have a round, circular or oval shape such as exemplarily illustrated in Figures. Preferably, the support element 100 is circumferentially closed.

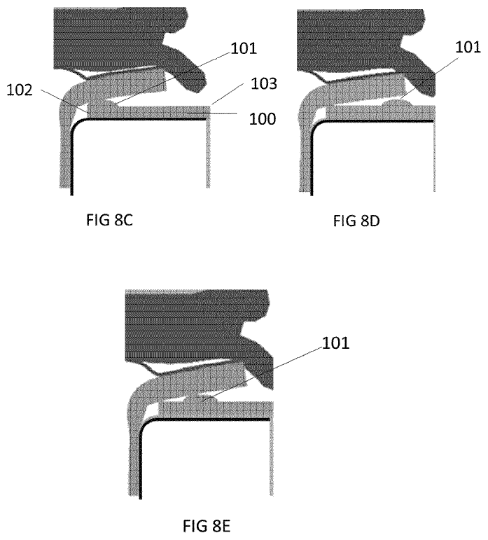

The annular support element 200 is configured in shape and size for being axially seated on the lower surface 242 of the capsule flange as illustrated in below FIGS. 8B to 8E.

The sidewall(s) 21 of the capsule body may guide the support element 100 to the coaxial arrangement. Thus, the diameter of the hole defined at the inner end 102 may correspond to the diameter of the capsule body. Accordingly, the inner opening 201 may be suitable and/or configured for receiving the capsule body 310.

Preferably, the width between the inner edge 102 and the outer edge 103 may be at least the width of the flange 24 of the capsule body to support the sealing area around the capsule.

The annular support element 100 may preferably have an axial thickness in a region of the support surface or at least in a region of the protruding portion, which is between 0.1 mm and 0.7 mm or between 0.3 mm and 0.5 mm. For example, the axial thickness may be higher if the annular support element 100 is made of a deformable material that can shrink when the injection plate and the capsule holder clamps the flange of the capsule and the annular support element since the axial thickness may reduce in the compressed state. For example, an annular support element 100 made of rubber with an axial thickness of 0.5 mm may be comparable in term of sealing force to an annular support element 200 made of steel with an axial thickness of 0.4 mm (this is because the rubber will shrink to 0.4 mm due to the clamping force).

FIG. 7 illustrates another alternative embodiment of the annular support element 100 of FIG. 4: the flat ring presents a capsule body supporting section 104 forming a capsule cage.

This section comprises an annular bottom portion 105 attached by ribs 106 to the lower surface of the annular support element 100. The centre of the annular bottom portion 105 is void to enable the passage of the bottom of the capsule body

With that embodiment, the positioning of the capsule inside the flat ring is obvious for the user; in particular if the flat ring comprises a protruding portion on its upper surface, then the user is automatically urged to position this upper surface below the lower surface 242 of the circumferential annular flange of the capsule. In addition, this capsule body supporting section 104 is so visible for the user that he/she is prevented from throwing away this flat ring away with the capsule after the beverage preparation.

In one embodiment, it is conceivable to provide the annular support element 100 integrally with the capsule holder 11. The support element 100 with the capsule holder 11 may be provided with the protruding portion 101.

During operation of the system for the preparation of a beverage, an annular support element according to any of the FIGS. 4 to 7 is positioned below the circumferential annular flange 24 of a capsule according to FIG. 1 and then the capsule is introduced in the capsule holder or alternatively, the annular support element is positioned above the circumferential rim of the capsule holder and then the capsule is introduced in the capsule holder.

Then the capsule holder is introduced in the receiving area 13 of the machine and the liquid injection plate is moved to enclose the capsule in the capsule holder and to puncture the top membrane of the capsule. Simultaneously, the flange 24 of the capsule with the top membrane 3 sealed thereto is clamped between the lower face of the injection plate and the upper surface of the annular support element, itself supported by the rim of the casual holder.

FIGS. 8A to 8E illustrate schematic cross-sections of the flange of the capsule clamped in the beverage preparation machine according to prior art and according to different embodiments of the system of the present invention.

FIG. 8A shows a schematic cross-section of a capsule extraction system as known in the prior art that is that does not comprise an annular support element whereas FIGS. 8A to 8E illustrates the system of the present invention.

In FIG. 8A, the flange 24 of the body capsule with the membrane 3 sealed to it is clamped between the rim 112 of the capsule holder and the injection plate 12.

In FIG. 8B, the capsule system further comprises an annular support element 100. The upper surface of the annular support element is planar as exemplarily shown in FIG. 4.

The annular support element 100 is configured such that, when it is seated on the lower surface 242 of the capsule body flange, a circumferential clamping region is created for clamping the capsule flange between the capsule holder 11 and the injection plate 12. This circumferential clamping region is a sandwich structure, which comprises a circumferential part of the flange (preferably comprising the sealing area), the first membrane 3 and the annular support element 100.

FIGS. 8C to 8E illustrates systems where the annular support element 100 comprises a protruding portion 102 on the upper surface contacting the lower surface 242 of the flange.

This protruding portion may be provided between the inner edge 220 and the outer edge 230 of the support element 200. This protruding portion is illustrated at different positions between the inner edge 102 and the outer edge 103. Preferably, the protruding portion may be provided such that it is radially closer to the inner edge 102 than to the outer edge 103.

This preference can be explained on the basis of FIGS. 9A and 9B which show schematic illustrations of forces and moments generated in a beverage preparation process for different embodiments of a capsule system according to the present invention. They illustrate exemplary how the structure of the annular support element 100, in particular the position of the protruding portion 101, may influence the tensions occurring in the sealing area when the capsule 1 is clamped inside the capsule holder and the injection plate.

It is conceivable that the annular support element 100 may comprise means to reliably place it at the intended position with respect to the capsule 1. For example, the annular support element 100 may comprise an alignment feature for ensuring its coaxial alignment with the capsule body. For example, the alignment feature may be a colour or a sticker, or a surface structure corresponding with a contour of the capsule body or the capsule holder.

The invention is not limited by the embodiments as described hereinabove, as long as being covered by the appended claims. All the features of the embodiments described hereinabove can be combined in any possible way and be provided interchangeably.

### LIST OF REFERENCES IN THE DRAWINGS

capsule 1
capsule body 2
chamber 20
sidewall 21
ingredient chamber 22
top opening 23
flange 24
upper surface 241
lower surface 242
bottom outlet 25
top membrane 3
sealing section 31
bottom membrane 4
opening device 5
rigid plate 51
opening elements 52
distributor wall 6
machine 10
capsule holder 11
   receiving area 111
   circumferential rim 112
liquid injection plate 12
   injection member 121
capsule holder receiving area 13
annular support element 100
   upper surface 100a
   lower surface 100b
   protruding portion 101
   inner edge 102
   outer edge 103
   capsule body supporting section 104
   annular bottom support portion 105
   rib 106

1. A system for producing a beverage in a beverage preparation machine, comprising:
a capsule, said capsule comprising:
a capsule body comprising:
a side wall defining a chamber and extending axially between a top opening and a bottom outlet
a circumferential annular flange projecting radially outward from the top opening, said flange comprising an upper surface opposite to the chamber with respect to the opening and an opposed lower surface,
and
a top membrane attached to at least a part of the upper surface of the circumferential flange, said top membrane closing the top opening, and adapted to be punctured for liquid injection into the capsule, and
a bottom membrane provided inside the chamber so as to define an ingredient chamber between the top membrane and said bottom membrane, said ingredient chamber containing a beverage ingredient, and
an opening device provided inside the chamber for opening the capsule by relative engagement of said opening device with the bottom membrane under the effect of a rise in pressure of the injected liquid in the ingredient chamber,
and
a beverage preparation machine comprising:
a capsule holder for receiving and holding the capsule in the beverage preparation machine, said capsule holder comprising:
a capsule receiving area configured to receive and hold the side wall of the capsule body, and
a circumferential annular rim extending radially outward from the receiving area and configured to support the circumferential annular flange of the capsule body,
and
a capsule holder receiving area for inserting the removable capsule holder, and
a liquid injection device,
wherein the liquid injection device and the inserted capsule holder are relatively moveable one to the other so as to clamp the circumferential annular flange of the capsule,
an annular support element positionable between the lower surface of the circumferential annular flange of the capsule and the circumferential annular rim of the capsule holder.

2. The system according to claim 1, wherein the capsule body is made of biodegradable materials.

3. The system according to claim 1, wherein the annular support element is a flat ring or a round ring.

4. The system according to claim 1, wherein the annular support element is made of a rigid material.

5. The system according to claim 1, wherein the annular support element is a flat ring, said flat ring comprising an upper surface configured to support the lower surface of the circumferential annular flange of the capsule body, and this upper surface comprises at least one annular protruding portion.

6. The system according to claim 1, wherein the protruding portion is provided between an inner edge and an outer edge of the ring, and wherein the protruding portion is provided at a position radially closer to the inner edge than to the outer edge of the ring.

7. The system according to claim 5, wherein the ring comprises an orientation feature for ensuring the ring being seated on the flange via the protruding portion.

8. The system according to claim 1, wherein the highest thickness of the annular support element, preferably at least in a region of the protruding portion, is comprised between 0.1 mm and 0.7 mm.

9. The system according to claim 1, wherein a capsule body supporting section is attached to the annular support element, said capsule body supporting section being designed to receive the capsule body when the circumferential flange (24) of the capsule body is seated on the ring.

10. (canceled)

11. A kit of at least one capsule and at least one annular support element configured to be used in a system for producing a beverage in a beverage preparation machine, comprising:
a capsule, said capsule comprising:
a capsule body comprising:
a side wall defining a chamber and extending axially between a top opening and a bottom outlet
a circumferential annular flange projecting radially outward from the top opening, said flange comprising an upper surface opposite to the chamber with respect to the opening and an opposed lower surface,
and
a top membrane attached to at least a part of the upper surface of the circumferential flange, said top membrane closing the top opening, and adapted to be punctured for liquid injection into the capsule, and
a bottom membrane provided inside the chamber so as to define an ingredient chamber between the top membrane and said bottom membrane, said ingredient chamber containing a beverage ingredient, and
an opening device provided inside the chamber for opening the capsule by relative engagement of said opening device with the bottom membrane under the effect of a rise in pressure of the injected liquid in the ingredient chamber,
and
a beverage preparation machine comprising:
a capsule holder for receiving and holding the capsule in the beverage preparation machine, said capsule holder comprising:
a capsule receiving area configured to receive and hold the side wall of the capsule body, and
a circumferential annular rim extending radially outward from the receiving area and configured to support the circumferential annular flange of the capsule body,
and
a capsule holder receiving area for inserting the removable capsule holder, and
a liquid injection device,
wherein the liquid injection device and the inserted capsule holder are relatively moveable one to the other so as to clamp the circumferential annular flange of the capsule,
an annular support element positionable between the lower surface of the circumferential annular flange of the capsule and the circumferential annular rim of the capsule holder,
said capsule comprising:
a capsule body comprising:
a side wall defining a chamber and extending axially between a top opening and a bottom outlet,
and
a circumferential annular flange projecting radially outward from the top opening, said flange comprising an upper surface opposite to the chamber with respect to the opening and an opposed lower surface,
and
a top membrane attached to at least a part of the upper surface of the said circumferential flange and closing the top opening, and adapted to be punctured for liquid injection into the capsule, and
a bottom membrane provided inside the chamber so as to delimit an ingredient chamber between the top membrane and said bottom membrane, said ingredient chamber containing a beverage ingredient, and
an opening device provided inside the chamber for opening the capsule by relative engagement of said opening device with the bottom membrane under the effect of a rise in pressure of the injected liquid in the ingredient chamber,
and
said annular support element being configured to be removably positioned below the circumferential annular flange of said capsule.

12. (canceled)

13. A ring configured to be used in a system for producing a beverage in a beverage preparation machine, comprising:
a capsule, said capsule comprising:
a capsule body comprising:
a side wall defining a chamber and extending axially between a top opening and a bottom outlet
a circumferential annular flange projecting radially outward from the top opening, said flange comprising an upper surface opposite to the chamber with respect to the opening and an opposed lower surface,
and
a top membrane attached to at least a part of the upper surface of the circumferential flange, said top membrane closing the top opening, and adapted to be punctured for liquid injection into the capsule, and
a bottom membrane provided inside the chamber so as to define an ingredient chamber between the top membrane and said bottom membrane, said ingredient chamber containing a beverage ingredient, and
an opening device provided inside the chamber for opening the capsule by relative engagement of said opening device with the bottom membrane under the effect of a rise in pressure of the injected liquid in the ingredient chamber,
and
a beverage preparation machine comprising:
a capsule holder for receiving and holding the capsule in the beverage preparation machine, said capsule holder comprising:
a capsule receiving area configured to receive and hold the side wall of the capsule body, and
a circumferential annular rim extending radially outward from the receiving area and configured to support the circumferential annular flange of the capsule body,
and
a capsule holder receiving area for inserting the removable capsule holder, and
a liquid injection device,
wherein the liquid injection device and the inserted capsule holder are relatively moveable one to the other so as to clamp the circumferential annular flange of the capsule,
an annular support element positionable between the lower surface of the circumferential annular flange of the capsule and the circumferential annular rim of the capsule holder, said ring comprises an upper surface and a lower surface, and the upper surface comprises an annular protruding portion.

14. A ring according to claim 1, wherein said ring comprises an orientation feature.

15-17. (canceled)
